(19) United States
(12) Patent Application Publication
(10) Pub. No.: US 2014/0129238 A1
(43) Pub. Date: May 8, 2014

(54) Remote Health Care Transaction Management System

(71) Applicant: Guardian eHealth Solutions, Inc., (US)

(72) Inventor: William Timothy Gray, Mercedes, TX (US)

(73) Assignee: GUARDIAN EHEALTH SOLUTIONS, INC., McAllen, TX (US)

(21) Appl. No.: 13/669,415

(22) Filed: Nov. 5, 2012

(51) Int. Cl. G06Q 20/14; G06Q 50/22

(52) U.S. Cl. CPC G06Q 20/14; G06Q 50/22
USPC 705/2

(57) ABSTRACT

A server facilitates and tracks a request for a change in patient care from a nurse and a responsive directive regarding that care from a physician as a transaction. Upon completion of the transaction by the physician in providing the responsive directive, the server automatically compensates the physician for processing the request. The server can require acknowledgment from the nurse that the responsive message was substantively responsive before declaring a transaction complete and therefore before compensating the physician for the response. Each user, whether a nurse or physician, can specify both (i) a schedule of days and times the user is scheduled to be available and (ii) one or more alternate users to which matter should be referred in times at which the user is not scheduled to be available.

### FIELD OF THE INVENTION

The present invention relates to networked data management systems, and more specifically to systems for conducting and managing transactions between cooperating health care professionals.

### BACKGROUND OF THE INVENTION

Health care service providers are under tremendous pressure to provide better care for lower costs. At the same time, aging demographics threaten to overwhelm current capacity for health care service providers. Reimbursements are being cut continuously, acerbating the problem of a looming primary care provider shortage. Furthermore, a lack of communication between health care providers has been repeatedly identified as one of the most crucial problems that must be addressed in order to improve patient outcomes. ACO's (accountable care organizations), bundled payments, and pay for performance are all creating additional pressure to force health care providers to cooperate with one another to produce better outcomes for lower costs.

It has been said that, to successfully build an ACO, hospital leaders will need to construct an effective ambulatory care management enterprise capable of treating patients with chronic diseases in low-cost community settings rather than high-cost inpatient facilities. For example, home health care is forecast to grow tremendously in the very near future. The result will be that a patient's primary care physician will be less likely to be present while care is being given. In no uncertain terms, this requires improved communications. Any situation where a health care provider is remotely located from the patient or other participating health care providers requires a secure HIPAA compliant communication solution.

In home health care, the patient stays at home and health care is provided in the home by a caretaker, usually a nurse. For most of the time, the care provided by the nurse is routine and competent. From time to time, the plan of care for the patient requires review or modification. For example, the nurse may observe a change in the patient's health or the plan of care may require review after a period of time.

The nurse is not authorized to change the plan of care provided. Any change in the patient's plan of care must be authorized by the primary care physician, and therefore requires communication with the primary care physician. Current law requires that any communication between health care providers be secure and in compliance with the Health Insurance Portability and Accountability Act of 1996 (HIPAA). Therefore, to change the care for the patient, the nurse sends a request to the primary care physician for review of the plan of care. Primary care physicians tend to be very busy, and these requests tend to pile up without receiving a response for some period of time.

The result is that the patient's care is not changed, often the patient's conditions worsens, and the patient is readmitted to a hospital, dramatically raising the costs of care for the patient.

What is needed is a system wherein the requests for a change in care and the responses thereto are better managed and facilitated.

In accordance with the present invention, a server facilitates and tracks a request for a change in patient care from a nurse and a responsive directive regarding that care from a physician as a transaction. Upon completion of the transaction by the physician in providing the responsive directive, the server automatically compensates the physician for processing the request. In conventional practices, each request for a change in patient care can take a relatively small amount of time to consider and respond to, providing little incentive to track the time and bill for it. As a result, many, if not most, of these requests go unanswered in conventional practices.

By tracking requests for changes in patient care and responses from physicians, the server described herein can track many small, yet valuable acts performed by the physician and compensate the physician for those acts. By documenting actions by the physician, automating the billing, payment, and collection processes for many such small acts, the substantial amount of time required to process numerous requests for changes in health care become worth the physician's limited and valuable time.

The end result is that requests for changes in patient care are processed much more quickly, the care provided to those requiring health care is dramatically improved, and the need for costly readmission to a hospital is significantly reduced.

In one embodiment, all physician responses to requests for review of a patient's plan of care are presumed to be appropriately responsive, triggering compensation of the physician, unless the nurse requests additional direction. In an alternative embodiment, to ensure that the physician's response is substantively responsive, i.e., addresses the essence of the change in care requested, the server can require acknowledgment from the nurse that the responsive message was substantively responsive before declaring a transaction complete and therefore before compensating the physician for the response.

To improve the quickness with which responses are received, each user can specify both (i) a schedule of days and times the user is scheduled to be available and (ii) one or more alternate users to which matter should be referred in times at which the user is not scheduled to be available. When the server receives a message, whether a request or response, addressed to a user who is not scheduled to be available at the current time, the server finds an alternate of the user wherein the alternative is scheduled to be available and delivers the message to that alternate. If no alternate is scheduled to be available at the current time, the server delivers the message to the user to whom the message is addressed. A user can also specify that messages intended to be delivered to the user are to also be sent to the user's alternates as a matter of course.

### A BRIEF DESCRIPTION OF THE DRAWINGS

FIG. 1 is a block diagram showing a server, a nurse device, and a physician device that cooperate through a computer network to manage transactions regarding change in patient care in accordance with the present invention.

FIG. 2 is a transaction flow diagram illustrating the manner in which the server, nurse device, and physician device of FIG. 1 cooperate through a computer network to manage transactions regarding change in patient care in accordance with the present invention.

FIG. 3 is a logic flow diagram illustrating the delivery of a message by the server of FIG. 1.

FIG. 4 is a logic flow diagram illustrating the registration of a user by the server of FIG. 1.

FIG. 5 is a block diagram illustrating the representation of a health care organization within the server of FIG. 1.

FIG. 6 is a block diagram illustrating the representation of a user within the server of FIG. 1.

FIG. 7 is a block diagram illustrating the representation of a transaction regarding change in a patient's care within the server of FIG. 1.

FIG. 8 is a block diagram illustrating the representation of a message within the server of FIG. 1.

FIG. 9 is a block diagram illustrating the server of FIG. 1 in greater detail.

FIG. 10 is a block diagram illustrating the nurse device of FIG. 1 in greater detail.

### DETAILED DESCRIPTION OF THE INVENTION

In accordance with the present invention, a server 102 tracks a transaction involving a request for a change in patient care from a nurse device 104 and a response from a physician device 106 and automatically compensates the physician user of physician device 106 for processing the request for a change in care.

It is helpful to consider an illustrative situation involving cooperative care of a patient provided by a nurse who is physically attending the patient and a physician who is remotely located. The patient may be at home or at some other low-cost community setting. The physician may be in a clinic, a hospital, or other location remote from the patient. It should be appreciated that the system described herein can be used for situations other than health care, e.g., legal, consulting, and other industries.

In conventional systems, a phenomenon sometimes called “micro-billing, for which a solution evades many professional services including health care, is the cause for delay in physician response to requests for changes in a plan of care for patients. Each request can take a relatively small amount of time to consider and respond to. Accordingly, there is little incentive for an already overwhelmed health care provider to track the time and bill for it. However, the requests can be many and the requisite time to consider and respond to all the requests can represent a substantial amount of time, time for which the physician cannot collect compensation.

By tracking requests for changes in patient care from a remotely located nurse device 104 and responses from a remotely located physician device 106, server 102 can track many small, yet valuable acts performed by the physician and compensate the physician for those acts. By automating the billing, payment, and collections for many such small acts, the substantial amount of time required to process numerous requests for changes in health care become worth the physician's limited and valuable time.

The end result is that requests for changes in home care are processed much more quickly, the care provided to those requiring home health care is dramatically improved, and the need for costly readmission to a hospital is substantially reduced in some cases.

Server 102, whose elements are described in greater detail below, communicates with nurse device 104 and physician device 106 through a wide area network 108. In this illustrative embodiment, wide area network 108 is the Internet—including wireless telephone data networks—and all communications are carried out using secure protocols.

Nurse device 104 is used by a user responsible for direct, in-person care of a patient who may be being cared for outside of a health care institution. For convenience of the reader, such a user is sometimes referred to herein as a “nurse”, though it should be considered that this is only one example of usage.

Physician device 106 is used by a user responsible for the type of care provided to a patient and who is authorized to make changes in that type of care, such as changing prescriptions as one example. For convenience of the reader, such a user is sometimes referred to herein as a “physician”, though it should be considered that people for whom the title of “physician” is not appropriate may also be responsible for the type of care provided to a patient.

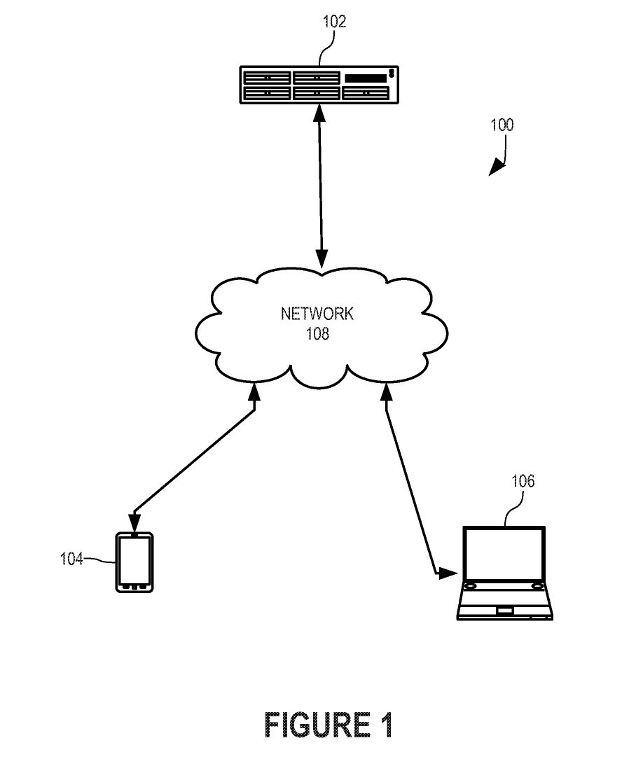

In FIG. 1, nurse device 104 is shown to be a smart phone and physician device is shown to be a laptop computer. It should be appreciated that (i) nurses can use laptops and physicians can use smart phones and that (ii) many other types of device can be used by nurses and physicians to conduct transactions in the manner described herein, including desktop computers and tablet computers. All that is required in this illustrative embodiment is that the device can process information, interact with a user, and communicate through a computer network.

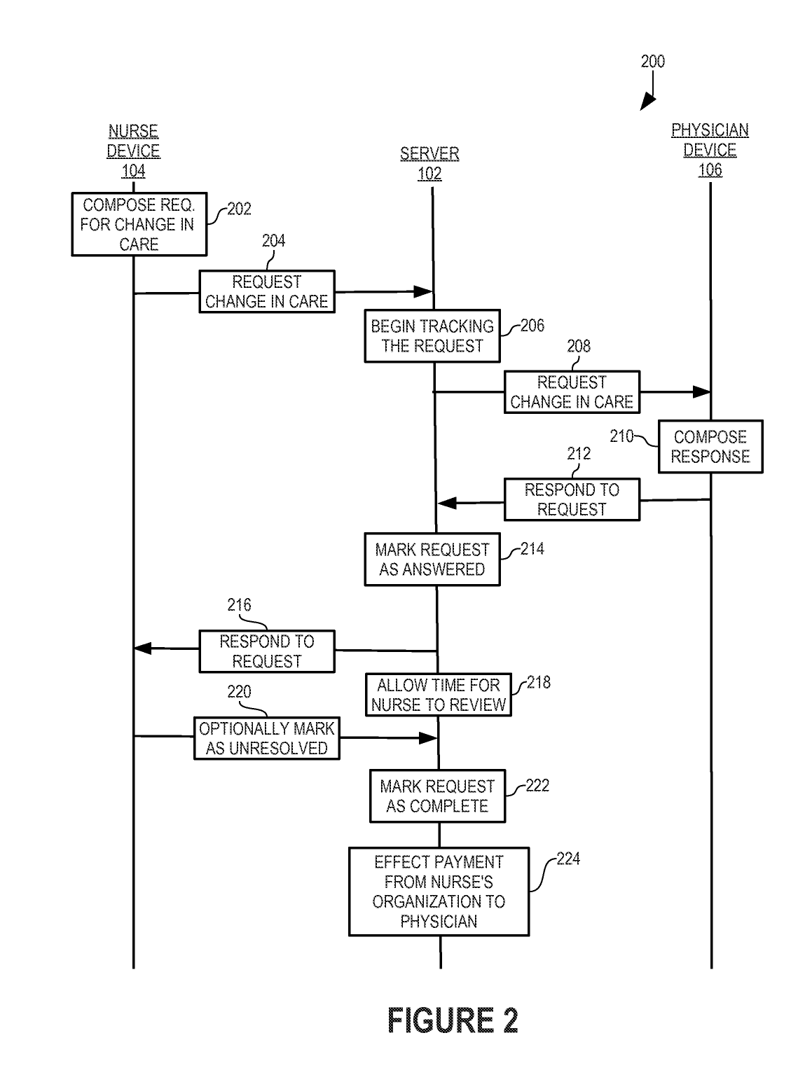

Transaction flow diagram 200 (FIG. 2) illustrates management and facilitation of a request for change in care between nurse device 104 and physician device 108 in accordance with the present invention. In the context of transaction flow diagram 200, a nurse is attending to a patient and has observed circumstances that suggest a change in the care provided to the patient is appropriate. However, the nurse has no authority to make the change in the care of the patient. Instead, that authority rests with a remotely located physician.

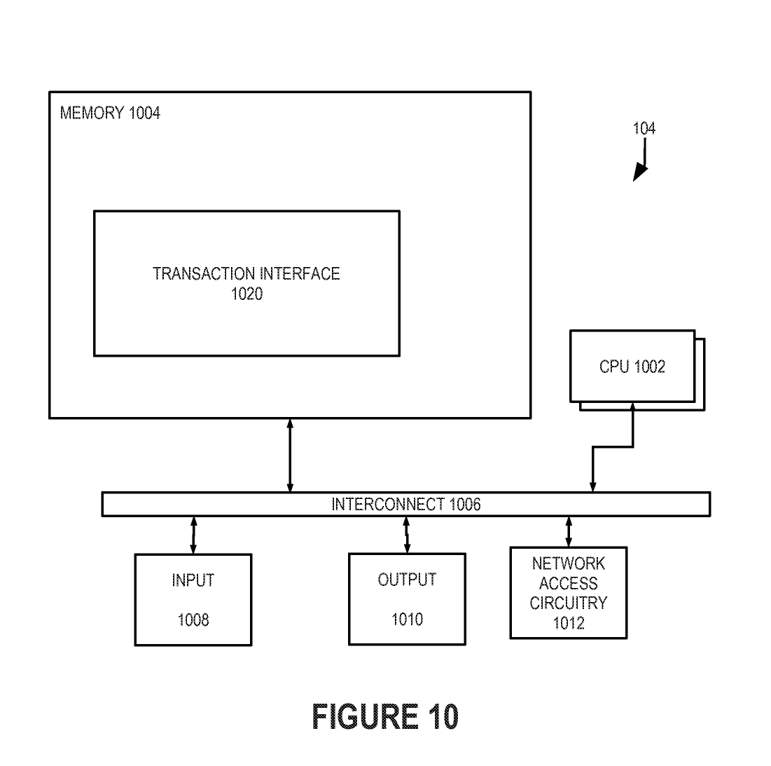

In step 202, the nurse uses nurse device 104 to compose a message requesting a change in care of the patient though a user interface of transaction interface 1020 (FIG. 10) that involves physical manipulation of one or more input devices 1008 by the nurse. As described more completely below, transaction interface 1020 implements the behavior of nurse device 104 as described herein.

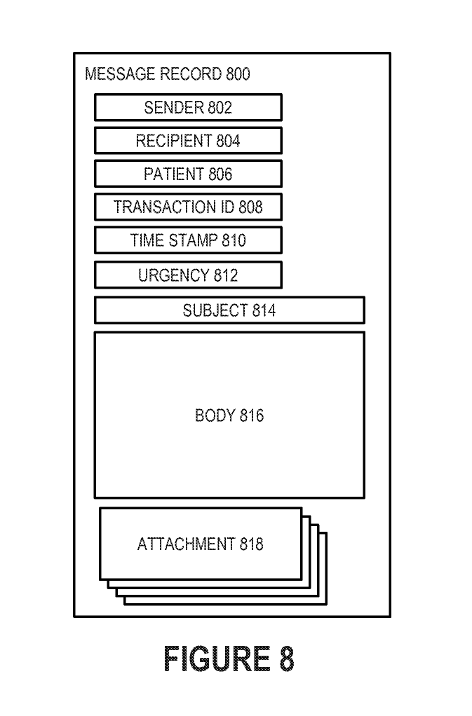

Message record 800 (FIG. 8) represents a message such as the one composed by the nurse in step 202. Sender 802 identifies the nurse as the source of the message. Recipient 804 identifies the intended recipient of the message. Patient 806 identifies the patient whose care is at issue. In composing the message, the nurse identifies the patient as such for representation in patient 806 and the patient's physician as recipient 804. The nurse can also skip step 202 to communicate with a physician with whom she shares no patient.

Since nurses and physicians often move around in performing their duties, it is expected that, in practice, nurse device 104 and physician device 106 will be small, portable devices such as smart phones. According, it is preferred that transaction interface 1020 provide a particular simple and optimized user interface. For example, rather than requiring the nurse to spell out alphanumeric data specifying recipient 804 and patient 806, transaction interface 1020 first allows the nurse to select patient 806 from a list of patients under the nurse's care. The patients under the nurse's care are specified by patient identifiers 626 (FIG. 6) in the user record 600 representing the nurse. Next, transaction interface 1020 allows the nurse to select recipient 804 from a list of physicians caring for the selected patient. The physicians caring for the selected patient are determined by finding user records of physicians for which patient identifiers 626 identify the selected patient. Thus, the nurse can identify recipient 804 and patient 806 in as little as one user-interface gesture each.

Transaction identifier 808 is a unique identifier of the transaction that includes all messages pertaining to the specific request embodied in the message composed in step 202. Since this message creates the transaction, the transaction does not exist at the time the message is composed by the nurse. Accordingly, in the message composed by the nurse in step 202, transaction identifier 808 is nil or some value that indicates no transaction is identified.

Time stamp 810 represents the date and time at which the message is created. Transaction interface 1020 (FIG. 10) stores the current date and time in time stamp 810 (FIG. 8) upon completion of composing the message by the nurse, e.g., in response to clicking of a “SEND” GUI button by the nurse in this illustrative embodiment.

Urgency 812 represents a relative urgency of the requested change in care, and therefore the message represented by message record 800. In this illustrative embodiment, transaction interface 1020 includes a graphical user interface (GUI) element that allows the nurse to select one of a number of predefined degrees of urgency, e.g., “High,” “Normal,” and “Low.” Examples of such a GUI element include radio buttons and a pull-down menu. In other embodiments, the nurse can specify a degree of urgency numerically or textually.

Subject 814 stores a textual summary of the subject matter of the message as entered by the nurse. Body 816 stores a textual body of the message as entered by the nurse. The nurse composes text that details the requested change in care for the patient and the observations and reasoning that is believed to warrant the change in care for storage in body 816. The nurse also composes a brief textual summary of the requested change in care for storage in summary 814. In some embodiments, subject 814 and/or body 816 can store rich text.

In some embodiments, transaction interface 1020 and server 102 cooperate to predict a few likely message subjects and corresponding message bodies. In one such embodiment, transaction interface 1020 keeps track of a few of the most recent message subjects and corresponding message bodies from the nurse to the same physician regarding the same patient and presents those most recent message subjects for selection by the nurse. If the nurse selects a recently used message subject, the corresponding recently used message body is automatically entered as the message body. The nurse is free to modify the recently used message subject and body prior to sending. Such allows the nurse to compose a complete message by making relatively minor changes to a similar, previously composed message.

In another such embodiment, server 102 has access to patient records and a knowledge base such that server 102 can predict a few most likely requests the nurse would make and offer them for selection by the nurse. In addition, transaction interface 1020 can provide a hierarchical menu structure by which most message subjects can be constructed from a few user-input gestures. For example, the nurse might select “significant change in vital signs” from a list of several types of messages, then select a particular vital sign from a list of vital signs, and then enter the numerical value of the vital sign to quickly and easily compose the message subject.

Message record 800 can also include one or more attachments 818, each of which is a data file attached to the message by the nurse. For example, one or more digital photographs may be attached to the message to corroborate the nurse's observations regarding the patient's state. In addition, one or more data files produced by health monitoring equipment can be attached to the message to provide more detailed information that the physician can use to make an informed decision regarding the care of the patient.

In some embodiments, transaction interface 1020 determines the nature of the attached documents and automatically pre-populates the message subject and/or body with a brief description of the attached documents. For example, if transaction interface 1020 recognizes that an attached document is a type that requires a physician's signature and does not include a physician's signature, transaction interface 1020 can pre-populate the message subject with “Physician signature requested” and can pre-populate the message body with “The attached document requires your signature.”

Once the nurse has composed the message using nurse device 104 in step 202 (FIG. 2), nurse device 104 sends the message to server 102 in step 204.

In step 206, server 102 begins tracking of the request. In particular, server 102 recognizes that transaction identifier 808 of the message received in step 204 represents a new transaction, i.e., no previously existing transaction. In response, server 102 creates a new transaction record 700 (FIG. 7) to represent a new transaction involving message regarding the particular change in care requested by the nurse.

Transaction identifier 702 is an identifier that is unique among all transaction identifiers used by server 102 and is used by message records such as message record 800 (FIG. 8) to link all messages regarding the particular change in care requested by the nurse.

Patient 704 identifies the patient whose care is at issue. Nurse 706 identifies the nurse that provides direct care to the patient. Physician 708 identifies the physician who is responsible for the plan of care given to the patient by the nurse and therefore authorized to make changes in the plan of care.

Status 710 represents the current status of the transaction. Initially, server 102 records the status of the current transaction as “open” to indicate that a request for change in care of the patient has been made and no response has been received from the physician.

In step 208 (FIG. 2), server 102 stores transaction identifier 702 as transaction identifier 808 of the message received in step 204 and sends the modified message to physician device 106 or, as described below in greater detail, to a predesignated alternative physician's device. Server 102 can also notify the physician associated with physician device 106 of the new message, particularly if the new message is of high urgency. Notification can be through any of a number of messaging techniques, including SMS messages to a mobile telephone, a facsimile transmission, an e-mail message, and an instant message through any of a number of instant messaging protocols for example.

In step 210 (FIG. 2), the physician uses physician device 106 to read the message and to compose a response to the message, i.e., to compose a responsive message. The message received by physician device 106 in step 208 is sometimes referred to as “the requesting message.” The physician reads the requesting message, reviews any attachments included with the message, and reviews any medical files of the patient to which the physician has access. In one embodiment, server 102 stores medical records of the patient and provides the physician remote access to the medical records.

To respond to the requesting message, the physician clicks a “REPLY” GUI button associate with the requesting message. In response, physician device 106 automatically populates sender 802, recipient 804, patient 806, transaction identifier 808, urgency 812, and subject 814 of the responsive message from recipient 804, sender 802, patient 806, transaction identifier 808, urgency 812, and subject 814, respectively, of the requesting message. Physician device 106 provides GUI elements by which the physician can modify urgency 812 and subject 814 and can enter a responsive textual body 816 for the responsive message. In this illustrative embodiment, physician device 106 automatically populates body 816 of the responsive message with a quoted version of body 816 of the requesting message to allow the physician to respond “in-line” in a manner that is well known and not described herein. The physician can also attach one or more attachments 818 to the responsive message.

The simplified, predictive user interface described above for composition of the requesting message can also be implemented for composition of the responsive message. For example, most recent responses for the same patient and nurse can be provided for selection by the physician using a single user-interface gesture. Simple responses such as “Approved”, “Denied”, and “Approved in part” can be provided. An “approve and sign” user-interface element can be provided such that, when actuated by the physician, transaction interface 1020 populates the subject and body with text indicating approval of the request and initiates a process by which the physician digitally signs any attached documents requiring her signature. Such user-interface enhancements make thoughtful response to the requesting message very easy and convenient for even the most busy of physicians in many situations.

In addition, physician device 106 provides the physician with an opportunity to sign the responsive message or to sign any documents that might have been attached to the message received in step 208. In one embodiment, the physician signs the message or the document by typing in an electronic “Is!” type of signature, such as “/Margaret D. Physician M.D./”. In another embodiment, the physician can sign using a finger or stylus on a touch-sensitive screen. In yet another embodiment, the physician can crytogaphically sign a message or document using an S/MIME certificate.

In response to clicking of a “SEND” GUI button, physician device 106 records the current date and time in time stamp 810 and sends the responsive message to server 102 in step 212 (FIG. 2).

In response to receiving the responsive message, server 102 marks the request as answered in step 214. In particular, server 102 identifies the subject transaction using transaction identifier 808 of the responsive message and changes status 710 of the subject transaction record to “answered.”

In step 216 (FIG. 2), server 102 sends the responsive message to nurse device 104, or a predesignated alternate of the nurse, and notifies the nurse recipient of the new message in a manner analogous to that described above with respect to step 208.

In step 218, server 102 initiates a timer, expiration which without indication from nurse device 104 that the transaction remains unresolved transfers processing to step 222. In step 222, server 102 marks the request as complete. In particular, server 102 determines the particular transaction to which the timer pertains and changes status 710 (FIG. 7) of the corresponding transaction record to indicate a status of “closed” or “complete” or some other value that indicates that the subject physician has provided an adequate and complete response to the request for change in care of the patient.

During the time provided in step 218, the nurse may determine that the responsive message received in step 216 is not adequately responsive to the message sent in step 204. To so indicate, the nurse can actuate a GUI checkbox or other GUI element provided by nurse device 104. Such sends notice data to server 102 in step 220 to indicate that the transaction remains unresolved, despite delivery of the responsive message in step 216.

Upon receipt of the notice data in step 220 prior to expiration of the timer set in step 218 and performance of steps 222 and 224, server 102 postpones performance of steps 222 and 224 until the transaction is indicated to be resolved. In some embodiments, the nurse simply uses a GUI “Reply” button to compose a new message in repeated performance of steps 202-218, except that transaction identifier 702 (FIG. 7) is included in the message sent in step 204 (FIG. 2).

Once the transaction is marked as complete in step 222, server 102 compensates the physician by effecting payment from the organization employing the nurse to the physician in step 224. Server 102 can effect payment by issuing a check to the physician and mailing the check to the physician or by wire or ACH (Automated Clearing House) using payment methods 622 (FIG. 6) specified by the physician.

In this illustrative embodiment, the amount paid to a physician is a fixed amount per transaction. Thus, once the transaction is marked as complete in step 220, a predetermined amount of money is transferred from the nurse's organization to the physician in step 222. In an alternative embodiment, server 102 determines the amount of time the physician spends reviewing the request message, the attachments of the request message, and the patient's medical records and compensates the physician at a predetermined amount per unit of time. This alternative embodiment works particularly well if the medical records are stored on server 102 and the time spent by the physician in reviewing both the request message and the medical records can be determined by server 102.

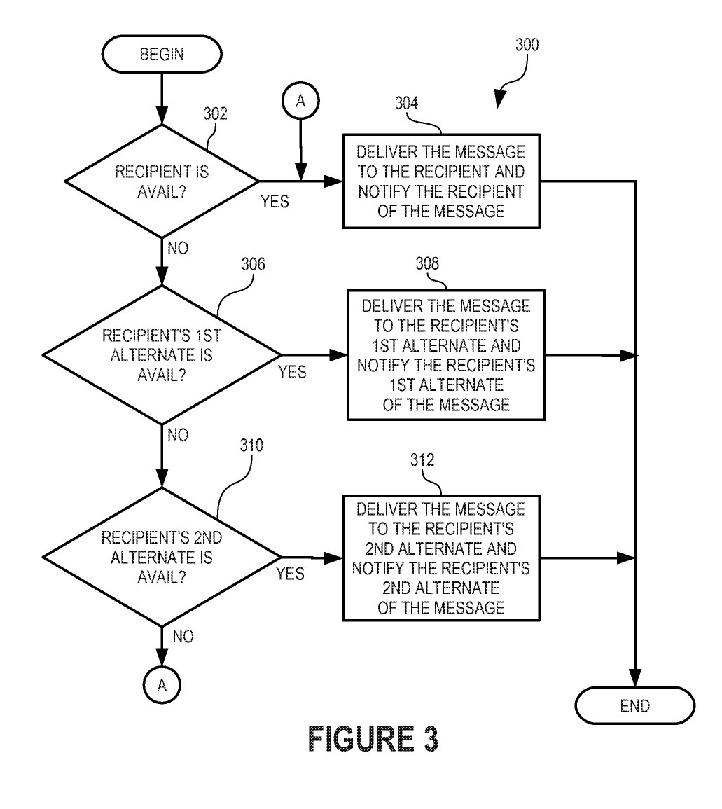

Logic flow diagram 300 (FIG. 3) illustrates message delivery of steps 208 (FIGS. 2) and 216 according to this illustrative embodiment. In test step 302 (FIG. 3), server 102 determines whether the recipient indicated by recipient 804 (FIG. 8) is available. To do this, server 102 retrieves a user record 600 (FIG. 6) representing the recipient. User record 600 includes a schedule 616 that indicates times at which the recipient is available. In this illustrative embodiment, schedule 616 specifies a weekly schedule of times of availability with a 30-minute granularity and specifies the time zone of the recipient.

If the recipient is currently available according to schedule 616, processing by server 102 transfers to step 304. In step 304, server 102 delivers the message to the intended recipient specified by recipient 804 (FIG. 8) and notifies the recipient of the new message. After step 304, message delivery according to logic flow diagram 300 completes.

If, in test step 302, server 102 determines that the recipient is not currently available, processing transfers to test step 306 in which server 102 determines whether the recipient's first alternate is currently available.

In this illustrative embodiment, user record 600 (FIG. 6) specifies up to two (2) alternate users 618. It should be noted that other embodiments can include more or fewer than two (2) alternate users 618. Each user, whether a nurse or physician, can specify one or more alternates that can handle the patient's case during times when the user is unavailable.

In test step 306, server 102 retrieves the user record 600 representing the first alternate of the recipient and determines whether the first alternate is available according to schedule 618 of the first alternate.

If the first alternate is currently available according to schedule 616, processing by server 102 transfers to step 308. In step 308, server 102 delivers the message to the first alternate and notifies the first alternate of the new message. After step 308, message delivery according to logic flow diagram 300 completes.

If, in test step 306, server 102 determines that the first alternate is not currently available, processing transfers to test step 310 in which server 102 determines whether the recipient's second alternate is currently available.

In test step 310, server 102 retrieves the user record 600 representing the second alternate of the recipient and determines whether the second alternate is available according to schedule 618 of the second alternate.

If the second alternate is currently available according to schedule 616, processing by server 102 transfers to step 312. In step 312, server 102 delivers the message to the second alternate and notifies the second alternate of the new message. After step 312, message delivery according to logic flow diagram 300 completes.

If, in test step 310, server 102 determines that the second alternate is not currently available, processing transfers to step 304 in which server 102 delivers the message to the intended recipient specified by recipient 804 (FIG. 8) and notifies the recipient of the new message as described above.

Thus, as illustrated by logic flow diagram 300, server 102 sends the message to the specified recipient if the recipient is available or none of the alternates for the recipient are available or to an available alternate according to the order specified by the recipient if an alternate is available.

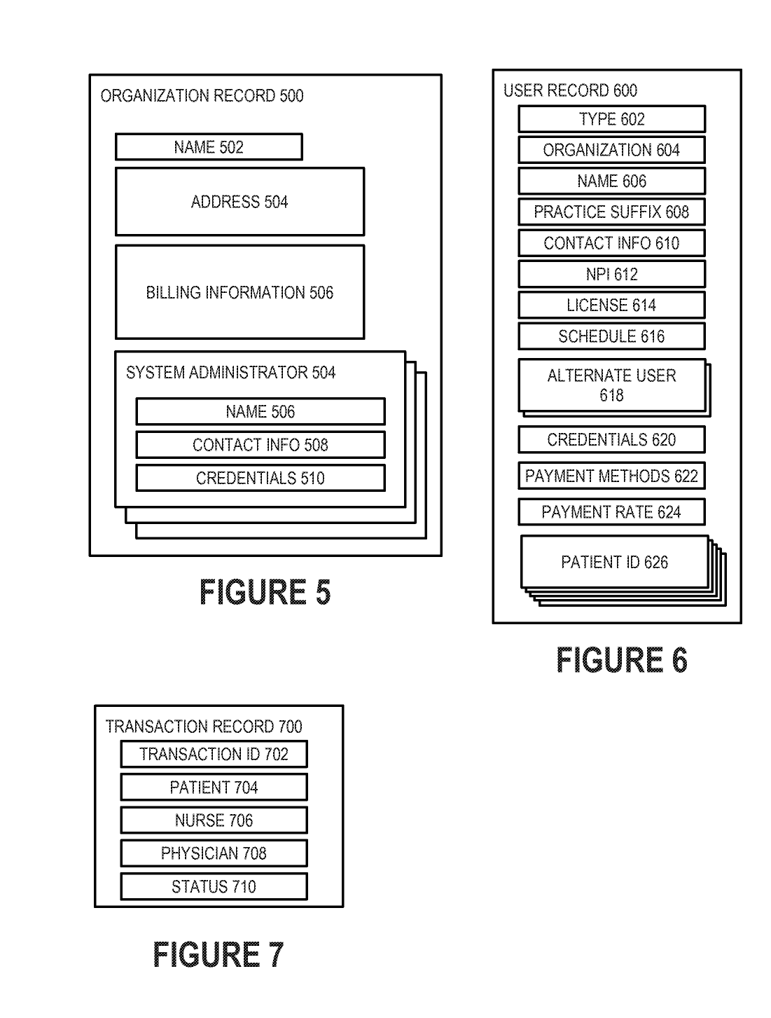

Each user, whether a nurse or physician, is associated with an organization, e.g., a business entity. Each organization is represented by an organization record 500 (FIG. 5). A name 502 specifies the name of the organization. The name can include both a full, legal name of the organization and a shorter name for the convenience of the users.

Organization record 500 also includes an address 504 that specifies general contact information for the organization, including a mailing address, telephone number(s), e-mail address(es), and a URL for a web site.

Billing information 506 provides bank account information sufficient to enable server 102 to effect payments to and from the organization as described above with respect to step 222 (FIG. 2). In some embodiments, billing information 506 (FIG. 5) also provides bank account information sufficient to enable server 102 to effect payment to the organization as well, obviating payment methods 622 (FIG. 6).

The organization can have a number of system administrators 504 who are authorized to create and maintain organization record 500 and user records 600 for all users associated with the organization. Each system administrator 504 includes a name 506 of the system administrator, contact information 508 of the system administrator, and credentials 510 of the system administrator. Name 506 can include a full, legal name and a short name by which the system administrator might be more commonly known. Contact information 508 can include telephone numbers and e-mail addresses for example. Credentials 510 are the credentials by which the system administrator is authenticated by server 102. In this illustrative embodiment, credentials 510 include a user name and a password. In embodiments in which a portion of contact information 508, e.g., an e-mail address, serves as a user name, credentials 510 can exclude a user name. It should be observed that many authentication protocols can be implemented by server 102, and credentials 510 stores whatever authentication credentials are required for the system administrator for the particular authentication protocol(s) used.

Each user of the system described herein, whether a nurse or a physician, is represented by a user record 600 (FIG. 6). Type 602 specifies the type of user that is represented by user record 600, sometimes referred to herein as the subject user in the context of FIG. 6. For example, type 602 can specify that the subject user is a nurse and what type of nurse or that the subject user is a physician and what type of physician.

Organization 604 identifies the particular organization record 500 (FIG. 5) with which the subject user is associated.

Name 606 (FIG. 6) specifies the name of the subject user and can specify both a full, legal name of the subject user and a short name by which the subject user might be more commonly known.

Practice suffix 608 specifies a practice suffix to be appended to the subject user's name. For example, a nurse might have the practice suffix, “R.N.”, and a physician might have a practice suffix such as “M.D.” or “M.O.”

Contact information 610 specifies ways the subject user can be contacted and can include telephone numbers, e-mail addresses, and such. Contact information 610 also specifies ways in which the subject user is to be notified of new messages in step 208 (FIG. 2) or 216, described above.

NPI 612 stores a National Provider Identifier (NPI) assigned to the subject user by National Plan & Provider Enumeration System (NPPES). License 614 identifies a professional license of the subject user.

Schedule 616 specifies the days and times at which the subject user is available as described above. Alternate users 618 specify users to contact at times when the subject user is not available as described above.

Credentials 620 specify credentials by which the subject user is authenticated by server 102. Credentials 620 are directly analogous to credentials 510 (FIG. 5) and the above description of credentials 510 is equally applicable to credentials 620 (FIG. 6).

Payment methods 622 specify one or more ways that payment to the subject user can be effected. If any of the payment methods involve electronic financial transfers such as wire transfers or ACH transactions, payment methods 622 provides sufficient bank account information to enable server 102 to effect such payment in step 222 (FIG. 2). As noted above, payment methods 622 (FIG. 6) can be omitted in embodiments in which billing information 506 (FIG. 5) specifies payment methods for all users of the organization.

Payment rate 624 (FIG. 6) specifies the rate at which the subject user is compensated for review of requests for changes in patient care. The rate can be a single fixed amount per review, can be a rate per unit of time, or can be either a fixed rate or a rate per unit of time for each degree of urgency of the request. In the context of professional services in health care, it is preferred that compensation be at Fair Market Value as required by the Stark law and the federal Anti-Kickback statute. It should be noted that delay by the physician in responding can reduce the Fair Market Value of her services and therefore reduce the amount she is paid for those services.

Patient identifiers 626 identify one or more patients under the care of the user.

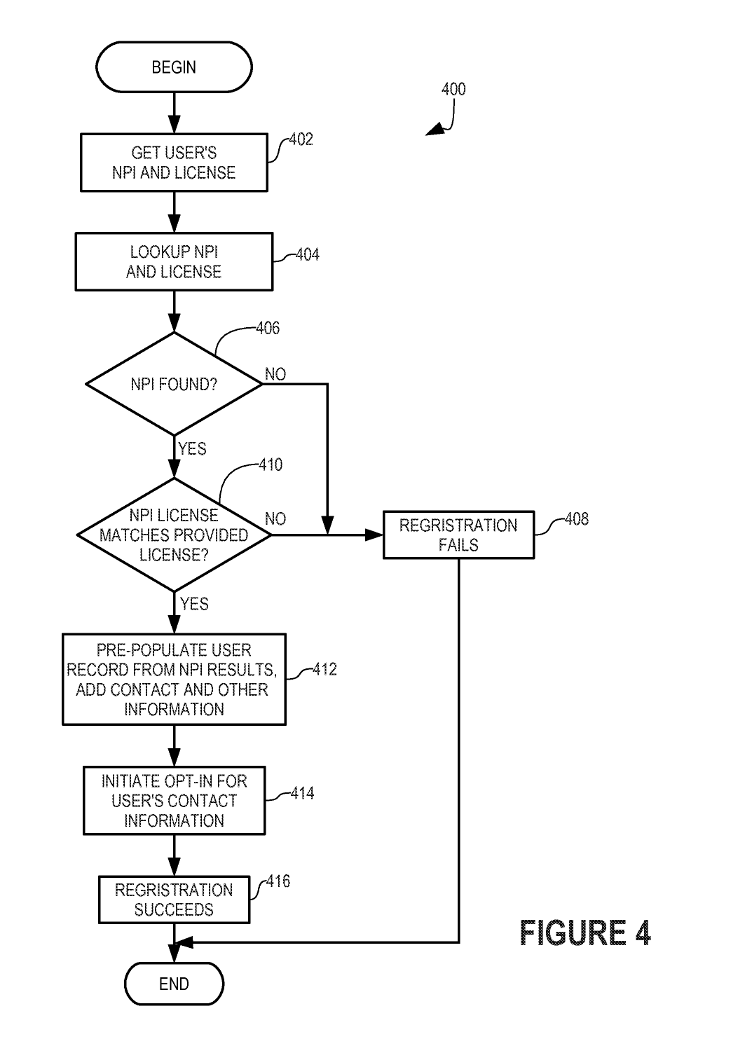

Logic flow diagram 400 (FIG. 4) illustrates the registration of a given user. In this illustrative embodiment, logic flow diagram 400 is implemented using an interactive web page transported over a secure channel through wide area network 108 between server 102 and physician device 106. Registration through nurse device 104 is analogous.

In step 402 (FIG. 4), the user enters the user's NPI and license information. In response to receipt of the NPI and license information in step 402, server 102 retrieves user information associated with the received NPI and license information using one or more known on-line servers that provide such information.

In test step 406, server 102 determines whether user information associated with the NPI and license was successfully retrieved. If not, processing transfers to step 408 in which registration of the user fails.

Conversely, if user information associated with the NPI and license information was successfully retrieved, processing transfers to test step 410 in which server 102 determines whether the license and NPI information retrieved using the known on-line servers matches the license and NPI information received in step 402. If not, processing transfers to step 408 in which registration of the user fails.

Conversely, if the license information retrieved using the NPI matches the license information received in step 402, the NPI and license information are considered adequate and processing by server 102 transfers to step 412.

In step 412, server 102 pre-populates various fields of a user record 600 for the user. For example, server 102 pre-populates NPI 612 and license information 614 with the NPI and license information received in step 402. In addition, server 102 pre-populates type 602, organization 604, name 606 (at least the full, legal name), practice suffix 608, and contact information 610 from information received from the NPI and license information retrieval in step 404.

In addition, server 102 provides a user interface by which the user can enter of modify fields other than NPI 612 and license information 614. Once the user confirms that all the fields are correct, e.g., by pressing a “SUBMIT” GUI button, processing by server 102 transfers to step 414.

In step 414, server 102 initiates an opt-in process for some of the contact information stored in contact information 610. For example, if the user has indicated that she should be notified of new messages by SMS messages to a mobile telephone, server 102 can send an SMS message to the mobile telephone directing the user to reply with “yes” if she agrees that new message notifications should be sent to that mobile telephone. Similarly, if the user has provided an e-mail address for notifications or other purposes, server 102 can send an e-mail message containing a confirmation link, actuation of which indicates that the user agrees that the e-mail address should be used for such purposes.

After step 414, registration of the user is successful in step 416.

One of the significant advantages of the system described above is an auditable record of communications between different organizations. In particular, some might doubt the advisability of home health care for a particular patient. Compensation by an insurer for such care may hinge on the ability to clearly establish that home health care is warranted.

By tracking communications between a home health care provider and a supervising physician, a clear history of the directions of the physician and the results in the patient's status can be reported. The status of the patient can be determined by the content of messages from the home health care nurse or by home health monitoring equipment.

In addition, the large reservoir of historical changes in health care administered by the home health care nurse and the results of those changes in the status of the patient's health provides a large store of data from which the best course of treatment for various situations can be determined. In short, recording changes in care of a patient and changes in the patient's status provides a basis for evaluating various hypotheses in the care of patients.

Another problem that is addressed by the system described herein is that of waiting for physician signatures. Currently, when a physician orders home health care for a patient, the patient contacts a home health care organization and arranges for home health care. The home health care sends a form to the doctor for his signature such that the home health care can be paid for, at least in part, by an insurer. Often times, the doctor takes a long time to sign the document. In the mean time, the home health care continues to provide services as needed. As time goes one, the amount due the home health care organization grows to uncomfortable levels. However, rather than terminate services, the home health care organization often continues to provide care in hopes of collecting compensation for all the care provided to date.

The reason that the physician delays in singing the requisite paper is often that the physician has a sizable stack of such papers and just doesn't have time to do the uncompensated work of signing them all.

In the system described herein, the amount of work required of the physician to respond to the request for signature is dramatically reduced. In addition, server 102 has information regarding the physician's history in responding to such requests. Accordingly, a physician that is unlikely to sign in response to such a request can be relatively quickly identified and the home health care organization can cease providing services before an excessive amount of accounts receivable have accrued.

In addition to the textual messages described above, many portable computing devices used by nurses and physicians in the system described herein will have voice communication capability, either in the form of Voice over Internet Protocol (VoIP) or native telephony capability in the device, such as a smart phone. In either case, transaction interface 1020 is aware of voice communications. In the case of VoIP, transaction interface 1020 implements the voice communication. In the case of native telephony capability, transaction interface 1020 uses a provided API to monitor the telephony state of the device.

Accordingly, transaction interface 1020 provides, in addition to the GUI “Reply” button described above, a GUI “Call” button by which the user can initiate a voice call to the recipient. In this illustrative embodiment and in situations in which recording the conversation is technologically feasible, the voice communications is recorded and transcribed using conventional speech-to-text logic.

In addition to facilitating communication by voice between a home health care nurse and a supervising physician, the system described herein can facilitate compensation for certain types of services by tracking and documenting services provided by the physician. For example, CMS (Centers for Medicare and Medicaid Services) compensate physicians when they spend over thirty (30) minutes providing care plan oversight (CPO) services. However, documenting and proving such services were provided is particularly challenging and much of such services go uncompensated.

In the system described herein, transaction interface 1020 knows when a voice call is initiated related to a message from a nurse regarding patient care. Transaction interface 1020 also knows when the voice call is terminated. When the voice call lasts longer than 30 minutes, transaction interface 1020 notifies server 102 of that fact, including a transaction identifier. In response to such notification, server 102 initiates billing CMS for the services on the physician's behalf.

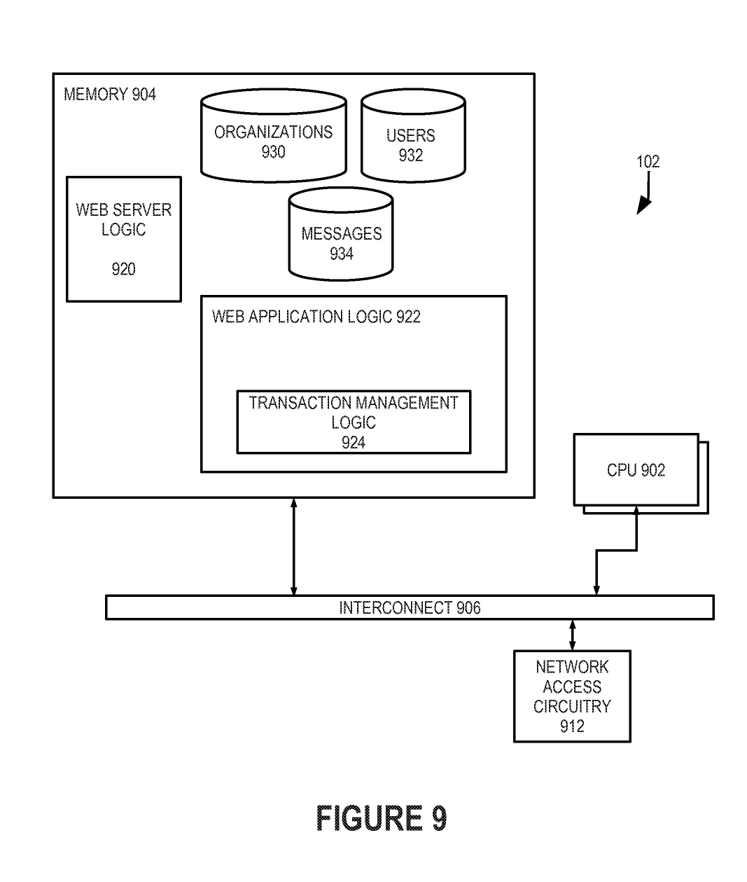

Server 102 is shown in greater detail in FIG. 9. Server 102 includes one or more microprocessors 902 (collectively referred to as CPU 902) that retrieve data and/or instructions from memory 904 and execute retrieved instructions in a conventional manner. Memory 904 can include generally any tangible computer-readable medium including, for example, persistent memory such as magnetic and/or optical disks, ROM, and PROM and volatile memory such as RAM.

CPU 902 and memory 904 are connected to one another through a conventional interconnect 906, which is a bus in this illustrative embodiment and which connects CPU 902 and memory 904 to network access circuitry 912. Network access circuitry 912 sends and receives data through computer networks such as wide area network 108 (FIG. 1).

A number of components of server 102 are stored in memory 904. In particular, web server logic 920 and web application logic 922, including transaction management logic 924, are each all or part of one or more computer processes executing within CPU 902 from memory 904 in this illustrative embodiment but can also be implemented using digital logic circuitry.

Organizations 930, users 932, and messages 934 are each data persistently stored in memory 904 and are each organized as all or part of one or more databases in this illustrative embodiment. Organizations 930 stores all organization records 500 (FIG. 5) for each organization having one or more users registered in the manner described above. Users 932 (FIG. 9) stores all user records 600 (FIG. 6) for all users registered in the manner described above. Messages 934 stores all message records 800 (FIG. 8) representing messages sent between users and all transaction records 700 (FIG. 7) representing transactions with which those messages are associated.

Web server logic 920 (FIG. 9) is a conventional web server. Web application logic 922 is content that defines one or more pages of a web site and is served by web server logic 920 to user devices such as nurse device 104 and physician device 106. Transaction management logic 924 is a part of web application logic 922 that implements the behavior of server 102 as described herein.

Nurse device 104 is a personal computing device and is shown in greater detail in FIG. 10. Physician device 106 is also a personal computing device and the following description of nurse device 104 in the context of FIG. 10 is equally applicable to physician device 106.

Nurse device 104 includes one or more microprocessors 1002 (collectively referred to as CPU 1002) that retrieve data and/or instructions from memory 1004 and execute retrieved instructions in a conventional manner. Memory 1004 can include generally any tangible computer-readable medium including, for example, persistent memory such as magnetic and/or optical disks, ROM, and PROM and volatile memory such as RAM.

CPU 1002 and memory 1004 are connected to one another through a conventional interconnect 1006, which is a bus in this illustrative embodiment and which connects CPU 1002 and memory 1004 to one or more input devices 1008, output devices 1010, and network access circuitry 1012. Input devices 1008 can include, for example, a keyboard, a keypad, a touch-sensitive screen, a mouse, a microphone, and one or more cameras. Output devices 1010 can include, for example, a display—such as a liquid crystal display (LCD)—and one or more loudspeakers. Network access circuitry 1012 sends and receives data through computer networks such as network 108 (FIG. 1).

Transaction interface 1020 is stored in memory 1004. Transaction interface 1020 is all or part of one or more computer processes executing within CPU 1002 from memory 1004 in this illustrative embodiment but can also be implemented using digital logic circuitry. As used herein, “logic” refers to (i) logic implemented as computer instructions and/or data within one or more computer processes and/or (ii) logic implemented in electronic circuitry. In one embodiment, transaction interface 1020 is a conventional web browser and the behavior of nurse device 104 and physician device 106 described above is specified by transaction management logic 924 (FIG. 9).

The above description is illustrative only and is not limiting. The present invention is defined solely by the claims which follow and their full range of equivalents. It is intended that the following appended claims be interpreted as including all such alterations, modifications, permutations, and substitute equivalents as fall within the true spirit and scope of the present invention.

What is claimed is:

1. A method for facilitating a transaction regarding a request for professional services, the method comprising:
detecting a requesting message from a requesting user through a computer network wherein the requesting message represents a request by the requesting user for professional services and that is directed to a recipient user;
detecting a responsive message from a responsive user through the computer network wherein the responsive message is responsive to the requesting message, represents results of professional services provided by the recipient user in response to the request, and is directed to the requesting user; and
in response to detecting the requesting message and detecting the responsive message, effecting payment from the requesting user to the responsive user.

2. The method of claim 1 wherein the request for professional services is a request for change in the care of a patient.

3. The method of claim 2 wherein the requesting user is a person directly administering care to the patient; and
further wherein the responsive user is a person authorized to direct the care administered to the patient.

4. The method of claim 2 wherein effecting comprises at least one selected from a group consisting essentially of:
effecting payment from an organization to which the requesting user belongs; and
effecting payment to an organization to which the responsive user belongs.

5. The method of claim 2 further comprising:
facilitating composition of the requesting message by presenting a list of patients associated with the requesting user for selection;
upon selection of the patient from the list of patients by the requesting user, presenting a list of physicians associated with the patient for selection by the requesting user; and
upon selection of the recipient user from the list of physicians, facilitating creation of the requesting message to the recipient user regarding the patient.

6. The method of claim 1 further comprising:
facilitating composition of the requesting message by the requesting user by at least:
for each of one or more elements of the requesting message: predicting one or more likely content selections for the element and presenting the likely content selections for selection by the requesting user.

7. The method of claim 1 wherein the detecting of the requesting message comprises receiving the requesting message from the requesting user through a selected one of at least one requesting device associated with the requesting user;
further wherein the detecting of the responsive message comprises receiving the responsive message from the responsive user through a selected one of at least one responsive devices associated with the responsive user.

8. The method of claim 7 wherein the detecting of the requesting message comprises:
determining whether the recipient user is scheduled to be available at the current time by reference to a predetermined schedule associated with the recipient user;
upon a condition in which the recipient user is scheduled to be available at the current time, delivering the requesting message to the responsive user wherein the responsive user is the recipient user; and
upon a condition in which the recipient user is not scheduled to be available at the current time, delivering the requesting message to the responsive user wherein the responsive user is a predetermined alternate recipient associated with the recipient user.

9. A non-transitory computer readable medium useful in association with a device which includes one or more processors and a memory, the computer readable medium including computer instructions which are configured to cause the device, by execution of the computer instructions in the one or more processors from the memory, to facilitate a transaction regarding a request for professional services by at least:
detecting a requesting message from a requesting user through a computer network wherein the requesting message represents a request by the requesting user for professional services and that is directed to a recipient user;
detecting a responsive message from a responsive user through the computer network wherein the responsive message is responsive to the requesting message, represents results of professional services provided by the recipient user in response to the request, and is directed to the requesting user; and
in response to detecting the requesting message and detecting the responsive message, effecting payment from the requesting user to the responsive user.

10. The computer readable medium of claim 9 wherein the request for professional services is a request for change in the care of a patient.

11. The computer readable medium of claim 10 wherein the requesting user is a person directly administering care to the patient; and
further wherein the responsive user is a person authorized to direct the care administered to the patient.

12. The computer readable medium of claim 10 wherein effecting comprises at least one selected from a group consisting essentially of:
effecting payment from an organization to which the requesting user belongs; and
effecting payment to an organization to which the responsive user belongs.

13. The computer readable medium of claim 10 wherein the computer instructions are configured to cause the device to facilitate a transaction regarding a request for professional services by at least also:
facilitating composition of the requesting message by presenting a list of patients associated with the requesting user for selection;
upon selection of the patient from the list of patients by the requesting user, presenting a list of physicians associated with the patient for selection by the requesting user; and
upon selection of the recipient user from the list of physicians, facilitating creation of the requesting message to the recipient user regarding the patient.

14. The computer readable medium of claim 9 wherein the computer instructions are configured to cause the device to facilitate a transaction regarding a request for professional services by at least also:
facilitating composition of the requesting message by the requesting user by at least:
for each of one or more elements of the requesting message: predicting one or more likely content selections for the element and presenting the likely content selections for selection by the requesting user.

15. The computer readable medium of claim 9 wherein the detecting of the requesting message comprises receiving the requesting message from the requesting user through a selected one of at least one requesting device associated with the requesting user;
further wherein the detecting of the responsive message comprises receiving the responsive message from the responsive user through a selected one of at least one responsive devices associated with the responsive user.

16. The computer readable medium of claim 15 wherein the detecting of the requesting message comprises:
determining whether the recipient user is scheduled to be available at the current time by reference to a predetermined schedule associated with the recipient user;
upon a condition in which the recipient user is scheduled to be available at the current time, delivering the requesting message to the responsive user wherein the responsive user is the recipient user; and
upon a condition in which the recipient user is not scheduled to be available at the current time, delivering the requesting message to the responsive user wherein the responsive user is a predetermined alternate recipient associated with the recipient user.

17. A device comprising:
at least one processor;
a computer readable medium that is operatively coupled to the processor;
network access circuitry that is operatively coupled to the processor; and
transaction management logic (i) that executes at least in part in the processor from the computer readable medium and (ii) that, when executed, causes the client device to facilitate a transaction regarding a request for professional services by at least:
detecting a requesting message from a requesting user through a computer network wherein the requesting message represents a request by the requesting user for professional services and that is directed to a recipient user;
detecting a responsive message from a responsive user through the computer network wherein the responsive message is responsive to the requesting message, represents results of professional services provided by the recipient user in response to the request, and is directed to the requesting user; and
in response to detecting the requesting message and detecting the responsive message, effecting payment from the requesting user to the responsive user.

18. The device of claim 17 wherein the request for professional services is a request for change in the care of a patient.

19. The device of claim 18 wherein the requesting user is a person directly administering care to the patient; and
further wherein the responsive user is a person authorized to direct the care administered to the patient.

20. The device of claim 18 wherein effecting comprises at least one selected from a group consisting essentially of:
effecting payment from an organization to which the requesting user belongs; and
effecting payment to an organization to which the responsive user belongs.

21. The device of claim 18 wherein the transaction management logic is configured to cause the device to facilitate a transaction regarding a request for professional services by at least also:
facilitating composition of the requesting message by presenting a list of patients associated with the requesting user for selection;
upon selection of the patient from the list of patients by the requesting user, presenting a list of physicians associated with the patient for selection by the requesting user; and
upon selection of the recipient user from the list of physicians, facilitating creation of the requesting message to the recipient user regarding the patient.

22. The device of claim 17 wherein the transaction management logic is configured to cause the device to facilitate a transaction regarding a request for professional services by at least also:
facilitating composition of the requesting message by the requesting user by at least:
for each of one or more elements of the requesting message: predicting one or more likely content selections for the element and presenting the likely content selections for selection by the requesting user.

23. The device of claim 17 wherein the detecting of the requesting message comprises receiving the requesting message from the requesting user through a selected one of at least one requesting device associated with the requesting user;
further wherein the detecting of the responsive message comprises receiving the responsive message from the responsive user through a selected one of at least one responsive devices associated with the responsive user.

24. The device of claim 23 wherein the detecting of the requesting message comprises:
determining whether the recipient user is scheduled to be available at the current time by reference to a predetermined schedule associated with the recipient user;
upon a condition in which the recipient user is scheduled to be available at the current time, delivering the requesting message to the responsive user wherein the responsive user is the recipient user; and
upon a condition in which the recipient user is not scheduled to be available at the current time, delivering the requesting message to the responsive user wherein the responsive user is a predetermined alternate recipient associated with the recipient user.
